(19) United States
(12) Patent Application Publication
(10) Pub. No.: US 2005/0072813 A1
(43) Pub. Date: Apr. 7, 2005

(54) Bottled liquid dispensers

(76) Inventors: Philip Andrew Walton, Bishop Auckland (GB); Clyde Pittaway, Darlington (GB); Craig Stares, Gateshead (GB)

Correspondence Address: Ira S Dorman, Suite 200, 330 Roberts Street, East Hartford, CT, 06108, US

(21) Appl. No.: 10/501,635

(22) PCT Filed: Jan. 24, 2003
(86) PCT No.: PCT/GB03/00256

(30) Foreign Application Priority Data
Jan. 24, 2002 (GB) 0201541.0

(51) Int. Cl. B67D 5/60

(52) U.S. Cl. 222/464.3

(57) ABSTRACT

A water cooler has a vertically elongate housing 1 with a dispensing recess 8 and a vertically elongate opening 10 located below the dispensing recess to receive a bottle of water 11. The bottle is supported on a fixed platform 18 which projects forward beyond the sides 15 and 16 of the opening for ease of loading. Liquid is removed from the bottle through an inclined dip tube which is raised and lowered by a lead screw and follower. The dip tube may be inserted through a probe which operates a bottle opening mechanism.

### TECHNICAL FIELD OF THE INVENTION

This invention relates to apparatus for dispensing liquids such as drinking water supplied from a bottle.

### BACKGROUND

The majority of existing bottled liquid dispensers have a vertically elongate housing which contains a reservoir from which the liquid can be dispensed through a discharge outlet. An example of such a dispenser is described in EP 0 581 491 A. The housing is normally substantially rectangular in plan view and its top face is formed with a seating to support the bottle in an inverted position with its neck downwards. Thus, liquid may flow from the bottle into the reservoir under gravity. Since the bottle is highly visible to users they are reassured that the liquid is coming from a known, uncontaminated source, but this arrangement also has significant disadvantages.

Full bottles are very heavy. They are difficult to carry and lift onto the dispenser, especially by people of small physical stature, making the task of changing bottles a daunting one for many people and even presenting the risk of serious back injury.

It has been proposed to load the bottle into the lower part of a rectangular housing and pump the liquid into the reservoir, as described in U.S. Pat. No. 4,852,621, U.S. Pat. No. 4,958,747, U.S. Pat. No. 5,540,355, U.S. Pat. No. 5,638,991, U.S. Pat. No. 5,833,096 and GB 2 268 925 A for example. However, the bottles still remain very difficult to handle, as demonstrated by the necessity to include a cart or trolley for use in loading the bottle into the dispenser. EP 1 022 251 A1 further proposes a water dispenser in which the water is dispensed from a post with the bottle supported on a base plate, but there is no housing to protect the bottle and there is a high risk of contamination of the dip tube when the bottle is replaced.

The present invention seeks to provide a new and inventive form of bottled liquid dispenser which eases the task of loading and handling the bottles whilst ensuring that good hygiene is maintained.

### SUMMARY OF THE INVENTION

The present invention provides a bottled liquid dispenser having:
a vertically elongate housing with a back, opposite sides and a front, the front of the housing having a dispensing recess and a bottle opening located below the dispensing recess to receive a bottle of liquid;
a reservoir contained within the housing;
at least one discharge outlet located at the top of the dispensing recess through which liquid is dispensed from the reservoir;
the bottle opening having a bottom forming a bottle-support platform, a top, and a pair of sides formed by said opposite sides of the housing; and
a dip tube for insertion into a bottle within the opening, said dip tube being in fluid communication with the reservoir,
   in which the front margin of the bottle-support platform is substantially part-circular and projects beyond the side margins of the bottle opening in a forward direction.

The invention also provides a bottled liquid dispenser having:
a dip tube for insertion Into a bottle;
a lead screw arranged to move a follower nut which is coupled to the dip tube to move the dip tube into and out of the bottle;
a motor for rotating the lead screw;
a reservoir in fluid communication with the dip tube to receive liquid from the bottle;
a pump arranged to cause movement of liquid from the bottle via the dip tube to the reservoir; and
at least one discharge outlet through which liquid is dispensed from the reservoir.

The invention further provides a bottled liquid dispenser having:
a hollow probe for insertion into a bottle;
means for moving the probe in and out of the bottle;
a dip tube for insertion into a bottle, the dip tube being arranged to pass through the probe into the bottle;
means for moving the dip tube into and out of the bottle;
a reservoir in fluid communication with the dip tube to receive liquid from the bottle;
a pump arranged to cause movement of liquid from the bottle via the dip tube to the reservoir; and
at least one discharge outlet through which liquid is dispensed from the reservoir.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a general view of a bottled liquid dispenser in accordance with the invention;

FIG. 2 is a side view of the dispenser, loaded with a bottle;

FIG. 3 is a front view of the dispenser, loaded with a bottle;

FIG. 4 is a general view of a dip tube drive mechanism for use in the dispenser;

FIG. 5 is a general view of a bottle opening mechanism which allows the dispenser to be used with self-sealing bottles;

FIGS. 6 and 7 are rear views of the bottle opening mechanism, showing the bottle opening probe in raised and lowered positions respectively;

FIG. 8 is a general view of an alternative form of door for the dispenser; and

FIGS. 9 and 10 are schematic diagrams showing two alternative arrangements for the internal components of the dispenser.

### DETAILED DESCRIPTION OF THE DRAWINGS

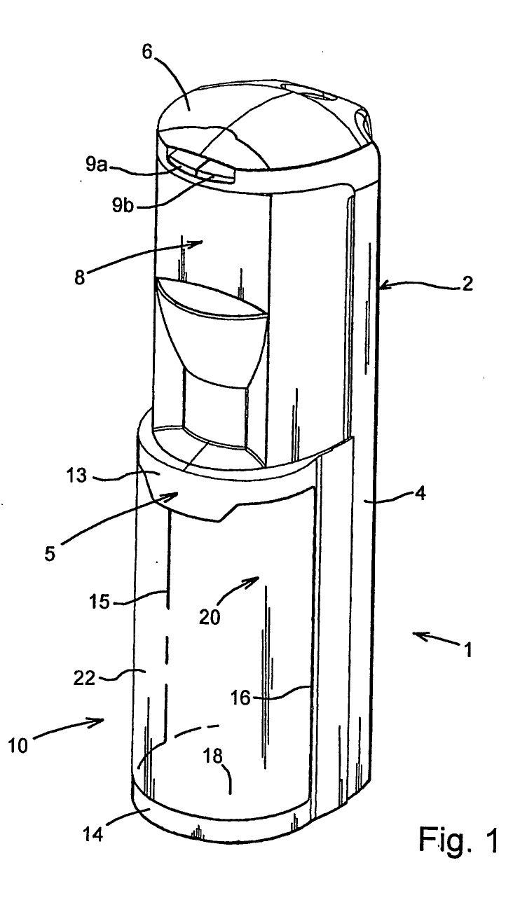

Referring to FIGS. 1 to 3, the illustrated form of bottled liquid dispenser, which is often referred to as a water cooler, has a vertically-elongate housing 1. The housing has a rear panel 2 which is substantially planar or slightly convex in plan view, and a pair of side panels 3 and 4 which are slightly convex in plan view and converge slightly in a forward direction where they join a substantially hemi-cylindrical front wall 5. The housing has a top 6 which may be aesthetically contoured as shown or substantially flat to act as a shelf for beverage-making items, marketing displays etc.

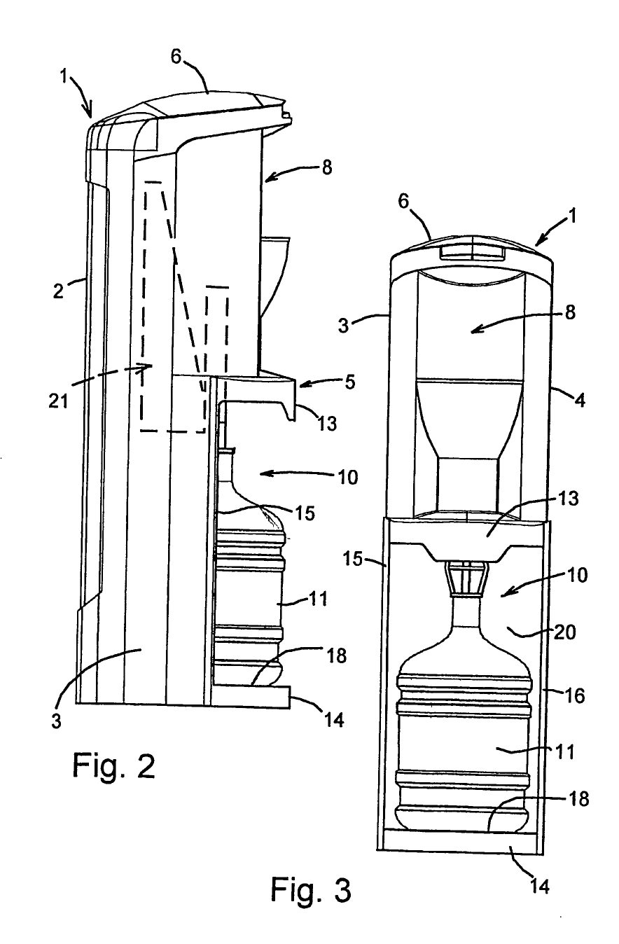

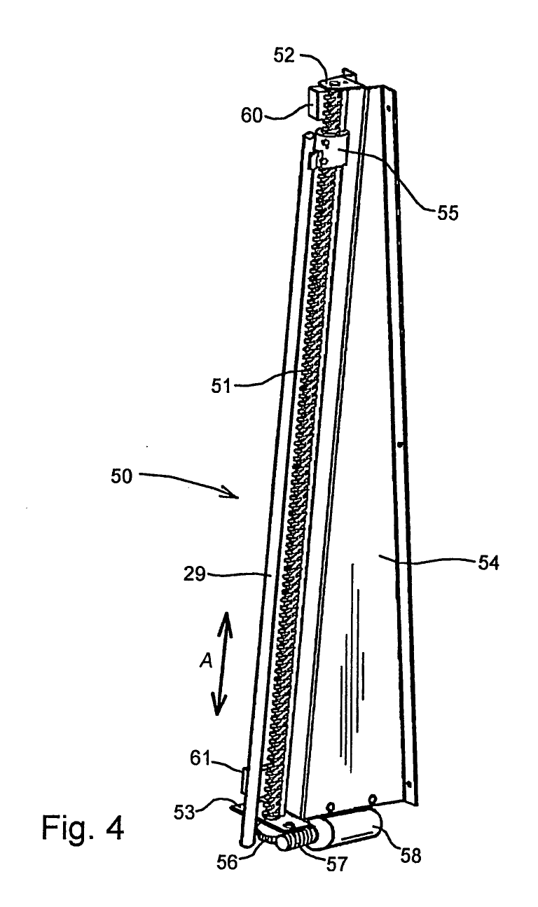

At the top of the front wall 5 there is a dispensing recess 8 within which hot and/or cold water may be dispensed into a cup or similar container by pressing one or more operating buttons 9a/b positioned immediately above the recess. Beneath the dispensing recess 8 the front wall contains an opening 10 for receiving a bottle of water 11, shown only in FIGS. 2 and 3. In the illustrated embodiment the height of the opening 10 is substantially twice its maximum transverse width. The top and bottom margins of the opening 10 are both substantially semi-circular, defined by upper and lower sections 13 and 14 of the front wall 5. The opposing side margins 15 and 16 of the display opening are substantially vertical and parallel, defined by the foremost edges of the curved side panels 3 and 4. The bottom of the opening 10 is formed by a fixed platform 18 with a substantially semi-circular front margin joined to the lower section 14 of the front wall 5. The rear wall 20 of the opening may be of any convenient shape, e.g. substantially planar, concave or hemi-cylindrical, provided it permits the bottle 11 to sit on the platform 18 without projecting beyond the front wall 5. Above the opening 10 and within the housing 1 there is a bottle connector assembly 21 (FIG. 2) which can be retracted for changing the bottle, described in greater detail below.

The front of the display opening 10 may be open as shown in FIGS. 2 and 3. Alternatively however, the opening may be provided with a substantially hemi-cylindrical transparent or opaque door 22, shown In FIG. 1, which may be hinged to one of the side margins 15 or 16. The door may simply enclose the top of the opening in order to protect the bottle connector assembly 21, or it may enclose the whole opening to provide a temperature-controlled environment around the bottle.

To load the bottle into the dispenser the bottle is lifted by means of its neck and partly placed onto the projecting platform 18. The bottle is then slid rearwardly into the centre of the platform. This can be achieved very rapidly and with little physical effort since placing the bottle onto a projecting platform, open at both sides, is considerably easier than trying to manoeuvre it through a rectangular opening.

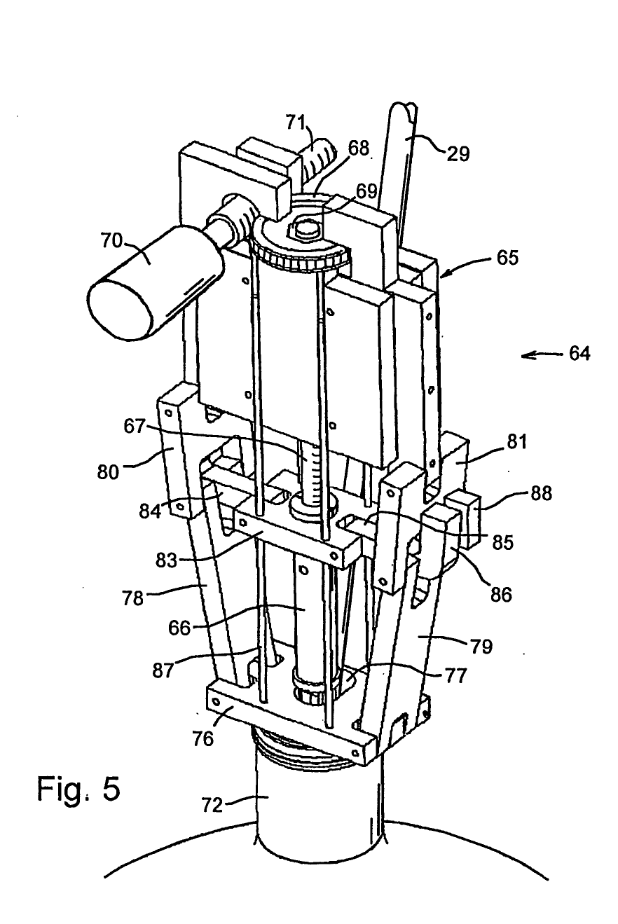

The bottle connector assembly 21 includes a dip tube drive system 50 which is shown in detail in FIG. 4. A lead screw 51 is rotatably mounted between brackets 52 and 53 secured to a frame 54 which holds the screw at an angle of about 10° to vertical. A screw follower nut 55 is received on the screw to releasably hold a dip tube 29, formed of a semi-rigid material, which is suitably guided for movement parallel to the screw. One end of the screw is fixed with a wheel 56 which is engaged by a worm 57 driven by a motor 58 such that the screw rotates to raise and lower the dip tube 29 in direction A, thereby moving the dip tube into and out of the bottle as required. The range of movement may be determined by engagement of the screw follower 54 with upper and lower limit switch sensors 60 and 61 which signal the motor to shut off.

The use of a lead screw and follower allows very accurate positioning and control of the dip tube avoiding lost motion effects. The inclination of the dip tube locates the intake at the side of the bottle to ensure that the bottle is completely emptied of liquid and also places the drive system in a more convenient position within the housing.

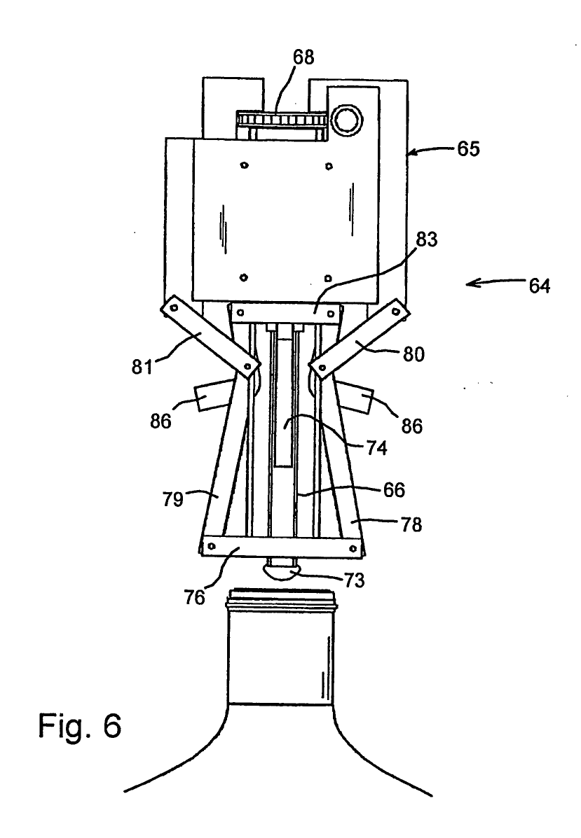

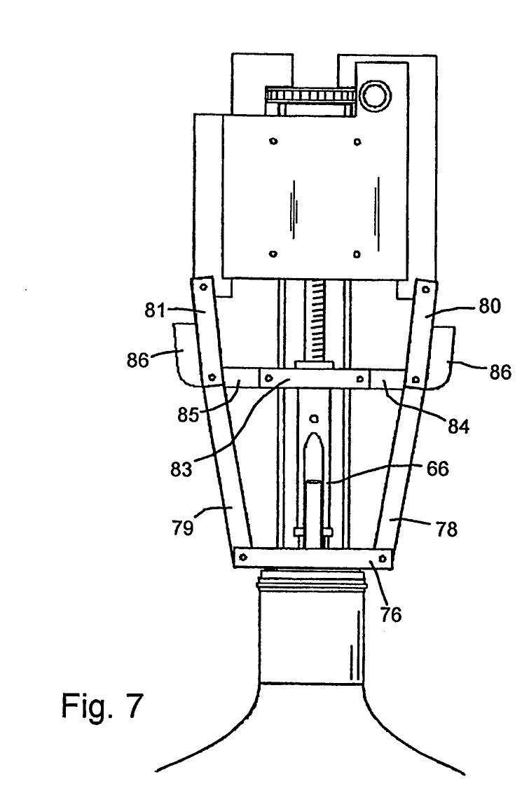

In some countries such as the USA water bottles are supplied with a simple tear-off seal which Is removed prior to loading the bottle allowing the dip tube to pass freely into the bottle. In some areas however, notably Europe, bottles are provided with a self-sealing cap which must first be physically opened to permit entry of a dip tube. The bottle connector assembly 21 may thus include a bottle opening mechanism 64, shown in FIGS. 5 to 7, which enables the cooler to be used with such bottles. A mounting plate assembly 65 is fixed in the cooler. A vertically mounted bottle opening probe 66 has a lead screw 67 at its upper end, which is axially guided in the mounting assembly 65. A wheel 68 is secured to a nut 69 which, in turn, is threaded onto the lead screw 67, and a reversible motor 70 rotates the wheel 68 by means of a worm drive 71. The wheel thus moves the screw 67 in an axial direction to move the probe between a raised portion, shown in FIG. 6, and a lowered position, inserted into the bottle, as in FIG. 7.

The bottle is provided with a self-sealing cap 72 of the kind having a removable internal plug as described in WO 90 03 919. The leading end of the probe 66 is formed with a head 73 which is shaped to open the cap by removing the internal plug and then replace it to re-seal the bottle when the probe is removed. As shown in FIG. 6, the probe 66 is provided with an axial slot 74, extending between opposite sides of the probe, through which the dip tube 29 may be angularly inserted when the probe is inside the bottle, as shown in FIG. 5.

The force required to withdraw the probe may be sufficient to lift an empty bottle, so the bottle opening mechanism 64 includes a clamp plate 76 to exert a downward pressure on the bottle cap while the probe is being withdrawn. The clamp plate has a central aperture 77 to receive the probe 66, and first toggle arms 78 and 79 are pivotally secured to opposite ends of the plate. The opposite ends of these toggle arms are pivotally secured to respective second toggle arms 80 and 81, which are in turn pivotally secured to the mounting plate assembly 65 on opposite sides of the lead screw 67. The toggle arms are also connected to a projecting flange 83 secured to the upper end of the probe 66 by means of a pair of link members 84 and 85 which are pivotally connected between opposite sides of the flange and the respective pair of toggle arms 78, 80 and 79, 81. When the probe is raised as in FIG. 6, the link members 84 and 85 pull the toggle arms inwards towards an angular position, lifting the clamp plate clear of the bottle, as shown. Lowering of the probe progressively moves the arms outward towards the position shown in FIGS. 5 and 7 which in turn lowers the clamp plate 76 Into clamping contact with the cap 72. Towards the end of the downward movement the toggle arms move over-centre to maintain downward pressure on the cap whilst relieving the probe of significant axial force. Angular stops 86 may be provided on the outer ends of the link arms to engage the toggle arms, as shown. During the first part of withdrawal of the probe 66 when the cap is being re-plugged, the bottle remains firmly held until the link members have moved sufficiently to reverse the over-centre movement of the toggle arms. The probe can then be freely withdrawn with the clamp plate raised.

Smooth operation may be ensured by guide rods 87 which project upwardly from the clamp plate 76, slidably inserted through the flange 83 and mounting assembly 65. Limit sensors such as 88 are provided to control the motor 70.

Movement of the probe 66 is coordinated with movement of the dip tube 29 so that the dip tube is withdrawn before the probe starts to be removed. Similarly, the dip tube is only inserted when the probe is lowered and the bottle is clamped.

Since positioning of the bottle opening probe 66 Is less critical than that of the dip tube other means of moving the probe could be used such as a rack and pinion.

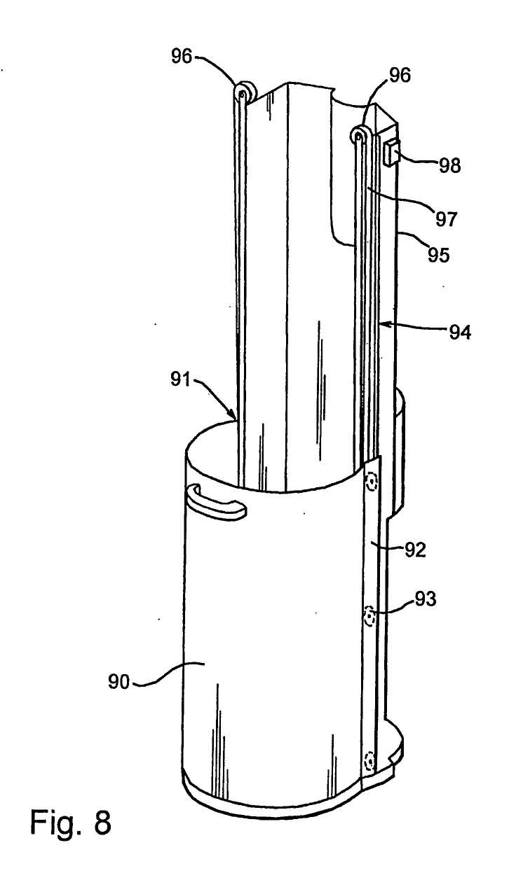

Instead of providing a hinged door as described above the bottle opening 10 may be provided with a parti-cylindrical sliding door 90, as shown in FIG. 8. The door can be slid up to cover the dispensing recess 8, discouraging attempts to use the cooler with the door open. The opposing vertical side margins 91 and 92 of the door are provided with rollers 93 which run in guide channels 94 secured to an internal chassis 95 within the housing 1. To assist raising of the door the weight of the door may be counter-balanced by constant tension springs 96 at the top of the channels 94, linked to the door by cords, cables or similar flexible elements 97. A limit switch 98 may be provided to sense when the door is raised and automatically operate the bottle opening mechanism 64 (if provided) and the drive system 50 to free the bottle.

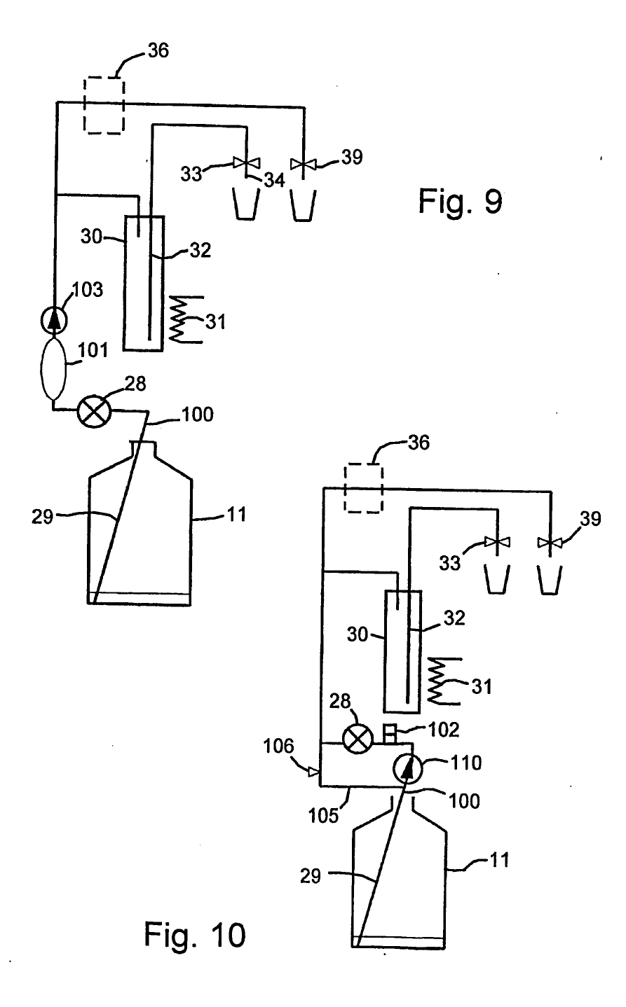

The internal components within the water cooler may be as shown in FIGS. 9 and 10. A centrifugal pump 28 removes liquid from the lower part of bottle 11 by means of the dip tube 29 to which it is connected by a length of flexible tubing 100. The pump supplies a chiller reservoir 30 provided with a cooling system 31. When a control valve 33 is opened by operation of button 9a the positive pressure provided by the pump 28 causes cooled water to leave the reservoir through a draw tube 32, and after passing through the control valve 33 the cooled water is dispensed through a discharge outlet 34 at the top of the recess 8. A hot tank 36 provided with a heating element may receive water from the pump and similarly dispense hot water through a further control valve 39 operated by second button 9b. The hot tank may be omitted to dispense water at ambient temperature if desired. Other known features can be included such as carbonation or oxygenation of the dispensed water, addition of fruit flavourings etc.

The use of an inexpensive pump which is not self priming is facilitated in FIG. 9 by the provision of an accumulator 101 between the pump and the reservoir. The accumulator may be a small elastic bladder or spring-loaded bellows for example. A non-return valve 103 prevents back-syphoning from the reservoir. The electrical current drawn by the pump may be sensed so that the pump is shut off as soon as air enters the pump. The lower end of the dip tube 29 may be provided with a spring-loaded plunger valve which is normally opened upon contact with the bottom of the bottle. Raising the dip tube causes the valve to close and ensures that there is no back-flow into the bottle. When the bottle is replaced the dip tube is lowered into the bottle causing the valve to re-open, and the accumulator then supplies a back-flow of liquid to re-prime the pump.

The arrangement of FIG. 10 also allows non-self-priming pumps to be used. A float switch 102 connected between the dip tube 29 and the pump 28 detects when air enters the system and shuts off the pump before it runs dry. The back pressure in the reservoir ensures that the pump remains primed to commence pumping from a new bottle, but a non-return valve 110 prevents back-flow into the bottle. A bypass 105 provided with a flow restrictor 106 may be connected from the output of the pump back to the dip tube to prevent over-pressure within the system.

Apart from the advantages discussed above there are other advantages to the system described. The water cooler has a low central of gravity compared with conventional coolers and there is no risk of leakages around the neck of the bottle. Replacement of the bottle can be achieved without risk of hand contact with the components of the bottle connector 21.

It will be appreciated that the features disclosed herein may be present in any feasible combination. Whilst the above description lays emphasis on those areas which, in combination, are believed to be new, protection is claimed for any inventive combination of the features disclosed herein.

1. A bottled liquid dispenser having:
a vertically elongate housing with a back, opposite sides and a front, the front of the housing having a dispensing recess and a bottle opening located below the dispensing recess to receive a bottle of liquid;
a reservoir contained within the housing;
at least one discharge outlet located at the top of the dispensing recess through which liquid is dispensed from the reservoir;
the bottle opening having a bottom forming a bottle-support platform, a top, and a pair of sides formed by said opposite sides of the housing; and
a dip tube for insertion into a bottle within the opening, said dip tube being in fluid communication with the reservoir;
in which the front margin of the bottle-support platform is substantially part-circular and projects beyond the side margins of the bottle opening in a forward direction.

2. A bottled liquid dispenser according to claim 1, in which the front margin of the bottle-support platform is substantially semi-circular.

3. A bottled liquid dispenser according to claim 1, in which the bottle-support platform is fixed relative to the housing.

4. A bottled liquid dispenser according to claim 1, in which the top of the bottle opening has a part-circular front margin which projets beyond the side margins of the bottle opening in a forward direction.

5. A bottled liquid dispenser according to claim 1, in which the distance between the top of the bottle opening and the bottle-support platform is substantially twice the distance between the sides of the bottle opening.

6. A bottled liquid dispenser according to claim 1, which includes a lead screw arranged to move a follower nut which is coupled to the dip tube to move the dip tube into and out of the bottle, and a motor for rotating the lead screw.

7. A bottled liquid dispenser according to claim 6, in which the dip tube is inclined relative to a vertical axis.

8. A bottled liquid dispenser according to claim 1, in which the bottle opening has a door of substantially hemi-cylindrical shape.

9. A bottled liquid dispenser according to claim 8, in which the door is arranged to slide over the dispensing recess.

10. A bottled liquid dispenser according to claim 8, in which movement of the door causes the dip tube to move into the bottle when the door is lowered and move out of the bottle when the door is raised.

11. A bottled liquid dispenser according to claim 1, which includes a hollow probe for insertion into the bottle and means for moving the probe in and out of the bottle, the dip tube being arranged to pass through the probe into the bottle.

12. A bottled liquid dispenser according to claim 11, in which the dip tube is angularly disposed relative to the probe and passes through the side of the probe.

13-20. (Cancelled)

21. A bottled liquid dispenser according to claim 1, in which a pump is connected between the dip tube arid the reservoir.

22. A bottled liquid dispenser according to claim 21, in which a liquid accumulator is connected between the pump and the reservoir.

23. A bottled liquid dispenser according to claim 21, including sensing means for stopping the pump when air is present in the liquid path between the dip tube and the pump.

24-28. (Cancelled)

29. A bottled liquid dispenser having:
a hollow probe for insertion into a bottle;
means for moving the probe in and out of the bottle;
a dip tube for insertion into a bottle, the dip tube being arranged to pass through the probe into the bottle;
means for moving the dip tube into and out of the bottle;
a reservoir in fluid communication with the dip tube to receive liquid from the bottle:
a pump arranged to cause movement of liquid from the bottle via the dip tube to the reservoir; and
at least one discharge outlet through which liquid is dispensed from the reservoir.

30. A bottled liquid dispenser according to claim 29, in which the dip tube is angularly disposed relative to the probe and passes through the side of the probe.

31.-38. (Cancelled)
